(19) United States
(12) Patent Application Publication
(10) Pub. No.: US 2025/0072384 A1
(43) Pub. Date: Mar. 6, 2025

(54) AUTOMATED CAT LITTER BOX

(71) Applicant: FURRYTAIL PET CORP, CHINO HILLS, CA (US)

(72) Inventors: Xiangtian Duan, Hangzhou (CN); Shuning Lian, Hangzhou (CN)

(21) Appl. No.: 18/821,405

(22) Filed: Aug. 30, 2024

(30) Foreign Application Priority Data
Aug. 31, 2023 (CN) 202311113591.9

(51) Int. Cl. A01K 1/01

(52) U.S. Cl. CPC A01K 1/0114

(57) ABSTRACT

The invention discloses an automated cat litter box, including a base and a cat litter box body. The cat litter box body includes a cat compartment, a litter collection space on the lower right of the cat compartment, and a waste collection compartment above the litter collection space. The cat compartment and the litter collection space are partitioned by a waste filter, and a mesh for cat litter entering the litter collection space. The cat compartment and the waste collection compartment are partitioned by a channel plate, a first waste collection port for clumped waste to flow out is hollowed out at one end of the channel plate, a second waste collection port is opened in the waste collection compartment at a position connected to the first waste collection port, and a waste compartment door is movably connected to and covered on the second waste collection port.

### FIELD OF THE INVENTION

The present invention relates to the technical field of pet products, and in particular to an automated cat litter box.

### BACKGROUND OF THE INVENTION

As living standards are continuously improved, more and more families choose pets as daily companions, especially in economically developed cities, a proportion of people raising pets is higher. However, due to a per capita housing area and a control on pets going out in the economically developed cities, more pet-raising populations prefer cats that do not require too much activity area. Feline pets need special cat litter for waste, and the cat litter needs to be cleaned regularly. However, when an owner is out and cannot clean the waste in time, hygiene of a cat litter box becomes poor, and health of a cat is further affected.

A cat litter box is a container for cats to defecate and go to the toilet. The cat litter box is usually made of plastic or other easy-to-clean materials and has edges to prevent cat litter from spilling. A cat owner pours the cat litter into the cat litter box where cats can squat and defecate. Using a cat litter box helps keep a home environment clean and gives cats a designated area to go to the toilet. It is important to clean the cat litter box regularly to ensure hygiene and comfort.

A main defect of a cat litter box in the related art is that a portion connected to a waste compartment is easily dirty due to frequent contact with clumped waste, and needs to be cleaned regularly. Many cat litter boxes do not have an independent structure to partition the cat compartment and the waste compartment, so that an entire cat compartment needs to be cleaned when the cleaning is required, which is inconvenient to operate.

### SUMMARY OF THE INVENTION

The present invention designs an automated cat litter box to solve the problem that the cat litter box in the related art is difficult to clean, and an object thereof is to provide a detachable channel plate between a waste compartment and a cat compartment. When the channel plate is dirty and smelly, the channel plate can be disassembled and cleaned separately without disassembling other structures, so that the cleaning method is more comfortable.

A technical solution employed in the apparatus relates to an automated cat litter box including: a base; and a cat litter box body located on the base, in which the cat litter box body includes a cat compartment, a litter collection space located on a right side of a bottom of the cat compartment, and a waste collection compartment located above the litter collection space, cat litter of a certain thickness is laid on a bottom surface of the cat compartment, the cat compartment and the litter collection space are partitioned by a waste filter, and a mesh for the cat litter to enter the litter collection space is provided on the waste filter, the cat compartment and the waste collection compartment are partitioned by a channel plate, a first waste collection port for clumped waste to flow out is hollowed out at one end of the channel plate, a second waste collection port is opened in the waste collection compartment at a position connected to the first waste collection port, and a waste compartment door is movably connected to and covered on the second waste collection port.

Preferably, the bottom of the cat compartment is a silicone surface, the cat litter is laid on the silicone surface, and Oxford cloth is laid under the silicone surface.

Preferably, the channel plate is a plastic plate, a plurality of pins are provided on both sides and an upper base of the channel plate, and two buckles are provided on a lower base of the channel plate.

Preferably, a bottom of the waste collection compartment is provided with a plurality of pin holes and two connection members, the pins of the channel plate are inserted into the pin holes, and the buckles are buckled with the connection members to fix the channel plate on the waste collection compartment.

Preferably, a vertical baffle is provided on a rear side of the base, a U-shaped latch is provided on the baffle, one end of the latch is fixedly riveted on the baffle and the other end of the latch is movably connected to the baffle, a cylindrical protrusion is provided on a rear side of the cat litter box body, the latch covers a circumference of the protrusion, and the movable end of the latch is buckled with the baffle, thereby fixing the cat litter box body on the base.

Preferably, two baffle pulleys are provided at a bottom of the baffle, and two baffle pulleys are also provided at an inner side of the latch.

Preferably, a base pulley is provided at each of four corners of a contact surface between the base and the cat litter box body.

Preferably, a material of the mesh of the waste filter is polypropylene, a thickness of the mesh is 2 mm to 3 mm, a material of an outer frame of the waste filter is PP plastic, and an aperture of the mesh of the waste filter gradually decreases from top to bottom.

Preferably, a base roller is installed under the base, and a cord storage compartment is provided at a rear side of the base.

Preferably, a front-to-rear length of the cat litter box body is larger than a front-to-rear length of the base, and when the cat litter box body is mounted on the base, a position of the cat litter box body protrudes forward.

Compared with the related art, the apparatus has the following beneficial effects.

(1) During a process of collecting waste in the cat litter box, the clumped waste crosses the channel plate provided between the waste collection compartment and the cat compartment, causing the channel plate to become dirty. In order to facilitate removal and cleaning, the channel plate is connected to the bottom of the waste compartment by the buckles and the pins, and the channel plate can be removed by pressing the buckles and pulling out the pins in sequence. Assembly and disassembly are convenient, so that the cat compartment does not need to be cleaned entirely during deodorization and cleaning, thereby optimizing a user experience.

(2) The vertical baffle is provided on the rear side of the base, the U-shaped latch is provided on the baffle, the cylindrical protrusion is provided on the rear side of the cat litter box body, the latch covers the circumference of the protrusion, and the movable end of the latch is buckled with the baffle, thereby fixing the cat litter box body on the base. The two baffle pulleys are provided at the bottom of the baffle, and the two baffle pulleys are also provided on the inner side of the latch. These four baffle pulleys exert an effect of reducing friction during rotation of the cat compartment, ensure the smooth rotation of the cat compartment, and avoid the cat compartment and the baffle from generating noise due to large friction.

(3) The base pulley is provided at each of four corners of the contact surface between the base and the cat litter box body, and these four base pulleys ensure that the cat compartment can rotate along a central axis, and can also exert an effect of reducing rotation resistance and noise. Other objectives and aspects of the invention will become apparent from the following detailed description, taken in conjunction with the accompanying drawings, which illustrate, by way for example, the features in accordance with embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference similar features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 is an exploded view of a structure of a cat litter box according to the present embodiment.

FIG. 2 is an overall structural diagram of the cat litter box according to the present embodiment.

FIG. 3 is a schematic diagram of a base of the cat litter box according to the present embodiment.

FIG. 4 is a top view of the base of FIG. 3.

FIG. 5 is a disassembled schematic diagram of a waste collection compartment of the cat litter box according to the present embodiment.

FIG. 6 is a disassembled schematic diagram of a channel plate inside a compartment of the cat litter box according to the present embodiment.

FIG. 7 is a schematic diagram of a baffle at a rear side of the base of the cat litter box according to the present embodiment and a latch on the baffle.

FIG. 8 is a diagram of a connection between the baffle and latch and the cat litter box.

### DETAILED DESCRIPTION OF THE INVENTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items or meant to be limited to only the listed item or items. It should be noted herein that any feature or component described in association with a specific embodiment may be used and implemented with any other embodiment unless clearly indicated otherwise.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification comprises references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems and methods are now described.

In order to make the object, features, and advantages of the invention of the present application more obvious and easy to understand, the technical solutions in the embodiments of the present application will be clearly and completely described below with reference to the accompanying drawings in the embodiments of the present application. Obviously, the embodiments described below are only some but not all the embodiments of the present application. Based on the embodiments in the present application, all other embodiments obtained by those skilled in the art without creative efforts fall within the scope of protection of the present application.

It should be understood that when used in the present specification and the attached claims, a term “including” indicates the presence of the described features, wholes, steps, operations, elements, and/or components, but does not exclude the presence or addition of one or more other features, wholes, steps, operations, elements, components, and/or collections thereof. It should also be further understood that a term “and/or” used in the specification and the attached claims of the present application refers to any combination of one or more of the associated listed items and all possible combinations, and includes these combinations.

In addition, terms “first” and “second” are only used to distinguish different structures, and cannot be understood as indicating or implying relative importance or implicitly indicating the number of indicated technical features. Therefore, a feature defined as “first” or “second” may explicitly or implicitly include one or more of the features. In the description of the present invention, a term “a plurality of” means two or more, unless otherwise clearly and specifically defined.

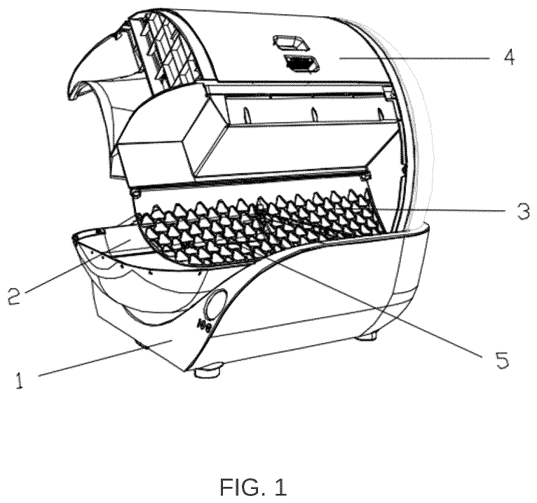

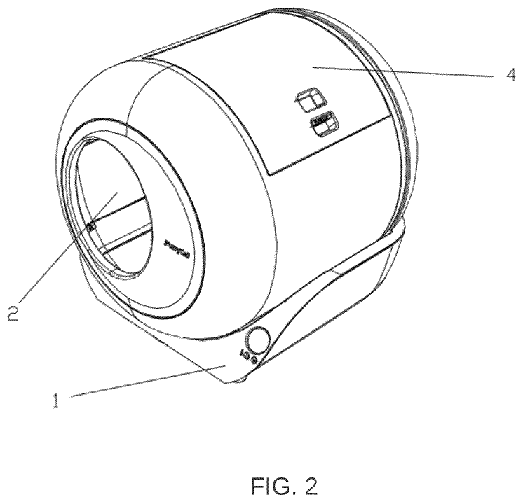

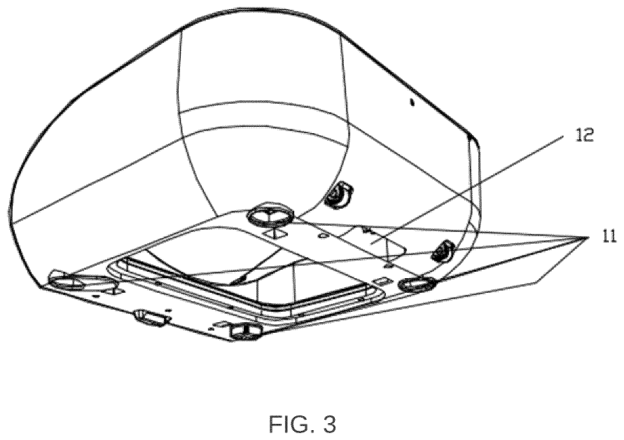

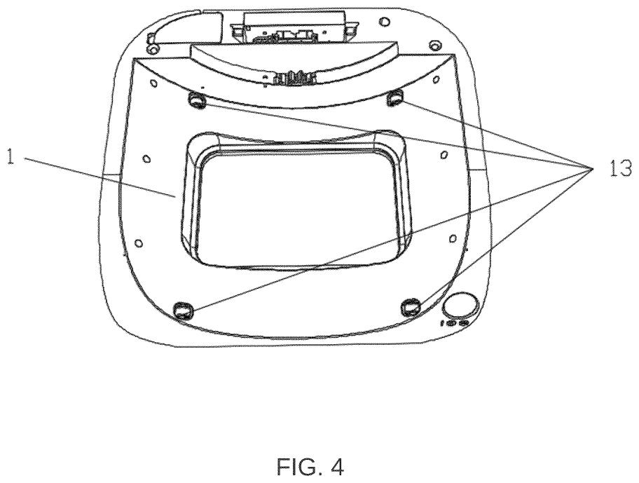

As shown in FIGS. 1 to 2, the present embodiment relates to a drum-type cat litter box, which includes a base 1 located at a lower side and a cat litter box body on the base 1. As shown in FIGS. 3 to 4, the base 1 is a U-shaped structure with a concave middle and protruding ends. A function display screen and function buttons are provided on a panel in front of the base 1, and various functions including rotating to collect waste and leveling litter. The base 1 is a hollow square groove in the middle, and is used to support a bottom of the cat litter box. Four corners of a contact surface between the base 1 and the cat litter box body are provided with base pulleys 13. The base pulleys 13 come into contact with the bottom of the cat litter box, and exert a positioning effect during the rotation of the cat litter box to ensure that the cat litter box rotates along a central axis of a cavity, and at the same time, the plastic base pulleys 13 can also reduce friction between the cat litter box and the base 1 during the rotation, so that the noise during the rotation is reduced. In addition, base rollers 11 are installed under the base 1, and a cord storage compartment 12 is provided at a rear side of the base 1. By providing the base rollers 11, the base 1 can be directly pushed when the cat litter box is moved, and the cat litter box thereon is driven to move together due to the rolling of the base rollers 11, making transportation easier and more convenient. The cord storage compartment 12 can store a power cord when the cat litter box is not working, and can also store a part of the power cord which is too long when the cat litter box is working, making the apparatus more pleasing to the eye as a whole.

As shown in FIG. 1, the cat litter box body mainly includes a cat compartment 2, a litter collection space 3, and a waste collection compartment 4. The cat compartment 2 is located in an inner cavity of the cat litter box body and is a place for a cat to move and defecate. A bottom of the cat compartment 2 is a silicone surface on which the cat litter is laid. Oxford cloth is laid under the silicone surface. The Oxford cloth can enhance a structural strength and prevent the silicone surface from being scratched by the cat. An object of setting the silicone surface is that clumped waste after the defecation of the cat adheres to the silicone surface, during rotation of the cat compartment 2, when the silicone surface rotates to a high position, the silicone surface deforms and expands, resulting in a smaller adhesion area, so that the clumped waste has weakened adhesion and is easy to fall off due to the gravity, and after the clumped waste falls to the bottom of the cat compartment 2, the clumped waste eventually falls into the waste collection compartment 4 along with subsequent rotation.

The cat compartment 2 and the litter collection space 3 are partitioned by a waste filter 5. The waste filter 5 is provided with a plurality of meshes for the cat litter to enter the litter collection space 3. A material of each mesh of the waste filter 5 is polypropylene, which has advantages of being moderately priced, durable, and waterproof. A thickness of the mesh is set to 2 mm to 3 mm to ensure that cat litter of most apertures can fall into the litter collection space 3 while clumped waste of most sizes is blocked. A material of an outer frame of the waste filter 5 is PP plastic, and about 40% to 50% of the non-permeable holes are used for the mesh to guide a flow and avoid clogging too quickly. The aperture of the mesh of the waste filter 5 gradually decreases from top to bottom to achieve multi-stage progressive filtration. A 30-degree inclination angle is designed between the top of the waste filter 5 and a shell of the cat litter box, so that the clumped waste slides down in time and does not accumulate on the shell.

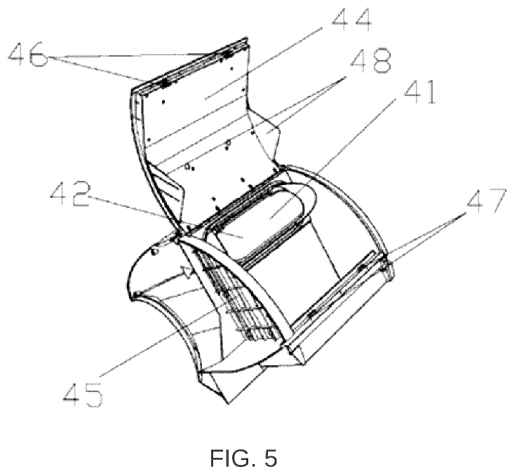

FIG. 5 shows a detailed structure of the waste collection compartment 4 including a waste compartment lid 44 and a waste compartment body 45. The waste compartment lid 44 is an arc-shaped lid plate, and is movably connected to the waste compartment body 45. Two buckles 46 are provided at a bottom edge of the waste compartment lid 44, and two buckle grooves 47 are provided at corresponding positions of the waste compartment body 45. When the waste compartment lid 44 is closed downward, the two buckles 46 are buckled into the buckle grooves 47, so that the waste compartment lid 44 covers the waste compartment body 45 to make the entire waste compartment a closed space. Triangular sheets 48 are provided on both sides of the waste compartment lid 44, and the triangular sheets 48 on both sides are pressed into the two sides of the waste compartment body 45, so that when the waste compartment lid 44 is closed, the waste collection compartment 4 has better sealing, and the odor is prevented from overflowing. The waste compartment body 45 is a cavity hollow inside and is provided with a second waste collection port 41 having a rounded rectangular shape. When the waste is collected by filtering the litter in the cat litter box, the clumped waste enters the waste collection compartment 4 through the second waste collection port 41 due to the gravity. The second waste collection port 41 is covered with a waste compartment door 42, one end of the waste compartment door 42 is fixed to one end of the second waste collection port 41, and the other end of the waste compartment door 42 is naturally fitted with the other end of the second waste collection port 41 due to the gravity. The waste compartment door 42 has a shape same as that of the second waste collection port 41, and has a bottom area larger than a cross-sectional area of the second waste collection port 41, and thus the waste compartment door 42 can only be opened toward one side of the waste compartment, and the opening and closing of the waste compartment door 42 is used to control the in and out of the clumped waste.

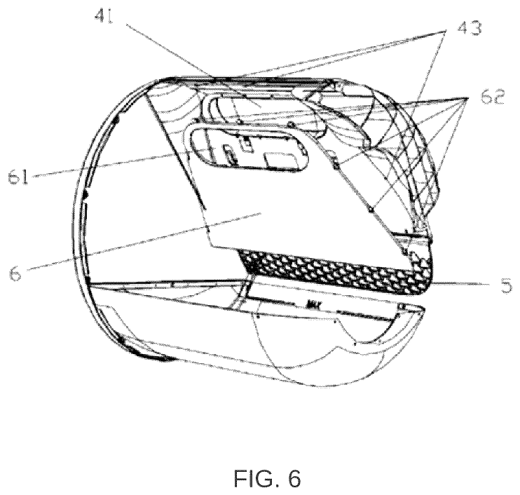

FIG. 6 shows a detailed structure of a channel plate 6. The channel plate 6 is located between the cat compartment 2 and the waste collection compartment 4 and serves as a partition. The channel plate 6 is a plastic plate having a trapezoidal structure. A plurality of pins 62 are provided on both sides and an upper base of the channel plate 6, and two buckles are provided on a lower base of the channel plate 6. A plurality of pin holes 43 and two connection members are provided at a bottom of the waste collection compartment 4. The pins 62 of the channel plate 6 are inserted into these pin holes 43, and the buckles are buckled with the connection members to fix the channel plate 6 on the waste collection compartment 4. One end of the channel plate 6 is hollowed out with a first waste collection port 61 for the clumped waste to flow out. The first waste collection port 61 is arranged opposite to the second waste collection port 41, and when the waste is collected by filtering the litter in the cat litter box, the clumped waste first crosses the channel plate 6 as the cat compartment 2 rotates, falls through the first waste collection port 61 due to the gravity, and then pushes the waste compartment door 42 to open, and falls into the waste collection compartment 4 through the second waste collection port 41.

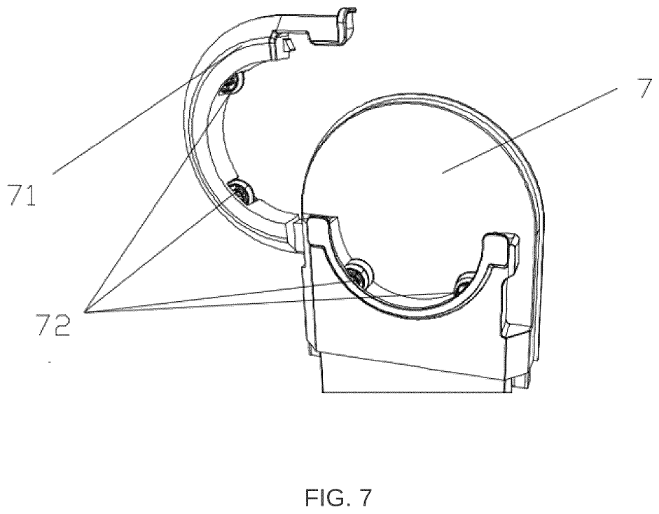

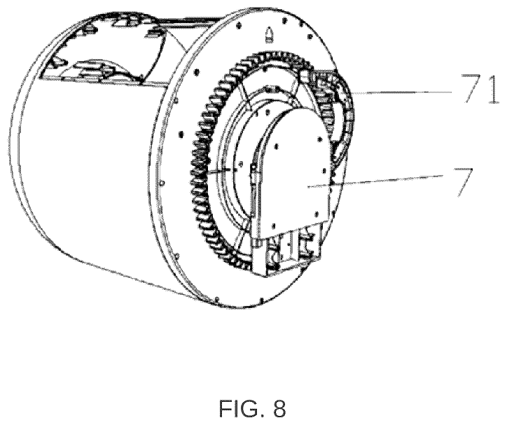

As shown in FIG. 8, a vertical baffle 7 is provided at the rear side of the base 1, and a U-shaped latch 71 is provided on the baffle 7 (FIG. 7 shows structures of the baffle 7 and the latch 71), one end of the latch 71 is fixedly riveted on the baffle 7, and the other end of the latch 71 is movably connected to the baffle 7. A cylindrical protrusion is provided at a rear side of the cat litter box body, the latch 71 covers a circumference of the protrusion, and the movable end of the latch 71 is buckled with the baffle 7, thereby fixing the cat litter box body on the base 1. In order to reduce noise caused by friction between the cat litter box and the baffle 7 during the rotation of the cat litter box, two baffle pulleys 72 are provided at the bottom of the baffle 7, and two baffle pulleys 72 are also provided on an inner side of the latch 71. These four baffle pulleys 72 can reduce the friction between the cat litter box and the baffle 7 during the rotation of the cat litter box, thereby reducing the noise during the rotation.

As can be seen from FIGS. 1 and 2, a front-to-rear length of the cat litter box body is larger than a front-to-rear length of the base 1, and when the cat litter box body is mounted on the base 1, a position of the cat litter box body protrudes forward. According to such a configuration, when the cat litter box rotates, the cat litter or clumped waste inside may roll out, and since the base 1 is set at the rear side, the spilled cat litter and clumped waste only spill on the ground, which is easy to clean. If the base 1 is provided at a front side of the cat litter box, some of the spilled cat litter and clumped waste may spill into a gap between the base 1 and the cat litter box body, which is easy to damage the cat litter box and also makes cleaning difficult.

A specific waste collection process and a working principle of the cat litter box according to the present embodiment are as follows. After a cat finishes defecating, cat litter stained with urine swells when encountering water, and in this case, there are mainly three kinds of materials in the cat compartment 2, that is, clean cat litter with a small aperture that is not in contact with the waste at the bottom, clumped waste with a large aperture, and dirty clumped cat litter with a large aperture that are stained with urine. For the convenience of description, the clumped waste and the dirty clumped cat litter are collectively referred to as the clumped waste. In response to activation of a waste collection function, the cat compartment 2 rotates clockwise by a first predetermined angle, so that the cat litter enters the litter collection space 3 through holes on the waste filter 5, the clumped waste continues to rotate and crosses the channel plate 6, and when the channel plate 6 rotates to the bottom, the clumped waste passes through the first waste collection port 61 due to the gravity, pushes the waste compartment door 42 to open, and finally enters a waste bag of the waste collection compartment 4 through the second waste collection port 41. After the waste collection is completed, the cat compartment 2 rotates counterclockwise by a second predetermined angle, so that the cat litter falls back from the litter collection space 3 into the compartment body, and during the rotation, the waste collection compartment 4 gradually rises to a high position, and the waste compartment door 42 gradually closes. Since the first predetermined angle is smaller than the second predetermined angle, the cat compartment 2 finally rotates clockwise to return to an original position.

Specifically, during the clockwise rotation of the cat compartment 2, the cat litter and the clumped waste move to the waste filter 5 at the same time, the cat litter with a smaller aperture enters the litter collection space 3 through the holes, and the clumped waste with a large aperture stays on the waste filter 5, and continues to move to the waste compartment door 42 along with the rotation. When the waste compartment door 42 rotates to the bottom, the waste compartment door 42 is opened due to the action of gravity, and the clumped waste naturally falls into the waste bag in the waste collection compartment 4. After the clumped waste completely falls into the waste bag, the cat compartment 2 rotates counterclockwise by the second predetermined angle, the clumped waste falls into the waste bag to the bottom due to the gravity, the waste compartment door 42 loses thrust and returns to a closed state, and at the same time, the clean cat litter in the litter collection space 3 falls back into the cat compartment 2 due to the gravity.

Specifically, the first predetermined angle is 130° to 170°, such as 130°, 145°, 152°, and 160°. If the first predetermined angle is too small, the clumped waste cannot reach the waste compartment door 42 and cannot enter the waste collection compartment 4, and if the first predetermined angle is too large, the clumped waste that falls into the waste collection compartment 4 may fall out of the waste collection compartment 4 due to the gravity. Therefore, by setting the first predetermined angle to 130° to 170°, the clumped waste can smoothly enter the waste collection compartment 4 without escaping from the waste collection compartment 4 along with the subsequent rotation. The second predetermined angle is 140° to 180°, such as 140°, 155°, 162°, and 170°. In an actual use, the second predetermined angle is set to be 100 larger than the first predetermined angle. According to such a setting, the waste filter 5 rotates counterclockwise to a certain height, so that the clean cat litter in the litter collection space 3 can fall back as fully as possible.

In addition to the waste collection function, the cat litter box according to the present embodiment further has a litter leveling function. In response to activation of the litter leveling function, the cat compartment 2 first rotates clockwise by a third predetermined angle, so that part of the cat litter falls into the litter collection space 3, and then the cat compartment 2 rotates counterclockwise by a fourth predetermined angle, so that the part of the cat litter falls back from the litter collection space 3 into the cat compartment 2. Here, the third predetermined angle is 50° to 80°, such as 55°, 70°, and 75°, the fourth predetermined angle is 60° to 90°, such as 65°, 75°, and 80°, and since the fourth predetermined angle is larger than the third predetermined angle, the cat compartment 2 needs to rotate clockwise again until the cat compartment 2 returns to the original position. The above constitutes a cycle of a litter leveling process. A complete litter leveling process requires 5 to 10 such cycles to ensure that the cat litter is fully leveled. According to the litter leveling, the cat litter can be laid flat in the cat compartment 2 to provide a suitable defecation environment for a cat.

The present invention and embodiments thereof have been schematically described above, and the description is not limiting. The structure shown in the drawings is merely one of embodiments of the present invention, and an actual structure is not limited thereto. Therefore, if those skilled in the art are inspired to design a structure and an embodiment similar to those of the technical solution without creativity and without deviating from the gist of the invention, the designed structure and embodiment should fall within the protection scope of the present invention. While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

1. An automated cat litter box, comprising:
a base;
a cat litter box body located on the base;
wherein the cat litter box body includes
a cat compartment, a litter collection space located on one side of a bottom of the cat compartment, and a waste collection compartment located above the litter collection space, wherein cat litter of a certain thickness is laid on a bottom surface of the cat compartment;
the cat compartment and the litter collection space are partitioned by a waste filter, and a mesh for the cat litter to enter the litter collection space is provided on the waste filter, the cat compartment and the waste collection compartment are partitioned by a channel plate;
a first waste collection port for clumped waste to flow out is hollowed out at one end of the channel plate;
a second waste collection port is opened in the waste collection compartment at a position connected to the first waste collection port; and
a waste compartment door is movably connected to and covered on the second waste collection port.

2. The automated cat litter box according to claim 1, wherein
the bottom of the cat compartment is a silicone surface;
the cat litter is laid on the silicone surface; and
an Oxford cloth is laid under the silicone surface.

3. The automated cat litter box according to claim 1, wherein
the channel plate is a plastic plate;
a plurality of pins are provided on both sides of the channel plate;
an upper base of the channel plate; and
two buckles are provided on a lower base of the channel plate.

4. The automated cat litter box according to claim 3, wherein
a bottom of the waste collection compartment is provided with a plurality of pin holes and two connection members;
the pins of the channel plate are inserted into the pin holes; and
the buckles are buckled with the connection members to fix the channel plate on the waste collection compartment.

5. The automated cat litter box according to claim 1, wherein
a vertical baffle is provided on a rear side of the base;
a U-shaped latch is provided on the baffle;
wherein one end of the latch is fixedly riveted on the baffle and the other end of the latch is movably connected to the baffle;
a cylindrical protrusion is provided on a rear side of the cat litter box body;
the latch covers a circumference of the protrusion; and
the movable end of the latch is buckled with the baffle, thereby fixing the cat litter box body on the base.

6. The automated cat litter box according to claim 5, wherein
two baffle pulleys are provided at a bottom of the baffle; and
two baffle pulleys are provided at an inner side of the latch.

7. The automated cat litter box according to claim 1, wherein
a base pulley is provided at each of four corners of a contact surface between the base and the cat litter box body.

8. The automated cat litter box according to claim 1, wherein
the mesh of the waste filter is a polypropylene material;
the mesh has a thickness of 2 mm to 3 mm;
an outer frame of the waste filter is a material made of Polypropylene plastic; and
an aperture of the mesh of the waste filter gradually decreases from top to bottom.

9. The automated cat litter box according to claim 1, wherein
a base roller is installed at a bottom of the base; and
a cord storage compartment is provided at a rear side of the base.

10. The automated cat litter box according to claim 1, wherein
a front-to-rear length of the cat litter box body is larger than a front-to-rear length of the base; and
a position of the cat litter box body protrudes forward when the cat litter box body is mounted on the base.
